(19) United States
(12) Patent Application Publication
(10) Pub. No.: US 2026/0092632 A1
(43) Pub. Date: Apr. 2, 2026

(54) Damping Mechanism Providing Resistance for Exercise System, and Exercise System

(71) Applicant: WISSON TECHNOLOGY (SHENZHEN) LIMITED, Shenzhen, Guangdong (CN)

(72) Inventors: Xiulin Chen, Shenzhen, Guangdong (CN); Beineng Liu, Shenzhen, Guangdong (CN)

(21) Appl. No.: 19/112,980

(22) PCT Filed: Sep. 28, 2023
(86) PCT No.: PCT/CN2023/122799

§ 371 Date: Mar. 19, 2025

(30) Foreign Application Priority Data
Sep. 29, 2022 (CN) 202211202657.7
Sep. 29, 2022 (CN) 202222601324.3
Sep. 29, 2022 (CN) 202222621831.3
Sep. 29, 2022 (CN) 202222636452.1

(51) Int. Cl. F16F 9/04; F16F 9/32; F16F 9/34

(52) U.S. Cl. CPC F16F 9/0472; F16F 9/3292; F16F 9/34

(57) ABSTRACT

A damping mechanism providing resistance for an exercise system, and the exercise system. The damping mechanism (100) comprises a first processor, a fixing portion (1), a movable portion (2) and a flow regulating valve (3). The fixing portion (1) is connected to a first exercise component (200). The movable portion (2) is connected to a second exercise component (300). The movable portion (2) divides the chamber of the fixing portion (1) into at least two fluid chambers (110) in communication with each other. When the first exercise component (200) and the second exercise component (300) move relative to each other, the movable portion (2) is driven to move to push the fluid to flow between the two fluid chambers (110). The damping mechanism uses the fluid resistance between the adjustable fluid chambers communicated with each other as a source of resistance, and is convenient and safe.

The present application claims the priority of the Chinese patent application filed on Sep. 29, 2022 before the CNIPA, China National Intellectual Property Administration with the application number of 202211202657.7 and the title of “Damping Mechanism and Exercise Device”, which is incorporated herein in its entirety by reference; further claims the priority of the Chinese patent application filed on Sep. 29, 2022 before the CNIPA, China National Intellectual Property Administration with the application number of 202222601324.3 and the title of “Flow Regulating Valve and Exercise Device”, which is incorporated herein in its entirety by reference; further claims the priority of the Chinese patent application filed on Sep. 29, 2022 before the CNIPA, China National Intellectual Property Administration with the application number of 202222636452.1 and the title of “Exercise Bottom Plate Structure and Exercise Device”, which is incorporated herein in its entirety by reference; and further claims the priority of the Chinese patent application filed on Sep. 29, 2022 before the CNIPA, China National Intellectual Property Administration with the application number of 202222621831.3 and the title of “Handlebar Structure and Exercise Device”, which is incorporated herein in its entirety by reference.

### TECHNICAL FIELD

The present application relates to the technical field of exercise equipment, and more particularly relates to a damping mechanism providing resistance for an exercise system, and the exercise system.

### BACKGROUND ART

With the improvement of people's living standards and the promotion of national exercise campaigns, more and more people utilize exercise machines as auxiliary equipment to exercise their bodies, wherein exercise equipment used in strength type training helps an exerciser obtain greater exercise intensity by providing resistance in a movement direction. The most widespread source of resistance in strength type exercise equipment is the gravity of balancing weights, other possible forms are elasticity, reluctance, physical friction, and the like, and boating machines also adopt blades moving in water tanks to provide resistance. For the most common sources of gravity and elastic resistance, generally a magnitude of the resistance is regulated by means of manually adding or reducing the balancing weights of the exercise equipment or regulating a pre-stress state of an elastic member, so as to adjust the exercise intensity. For sources of gravity or other types of resistance, automatic or semi-automatic regulation may be achieved by means of electric control combined with machinery, for example, an angle of the blade, a size of a frictional area, and the like, are regulated manually or electrically, wherein the regulation in a manner of providing the resistance by a reluctance motor is relatively convenient, but the power and cost required for providing unit resistance are relatively high, and thus conventional exercise equipment with the source of gravity resistance is still most widely used at present. During exercise, it is necessary for a user to stop exercise and self-regulate or auxiliary personnel such as an exercise trainer to help regulate a resistance value of the exercise equipment, which may undoubtedly cause the interruption of complete user experience. Meanwhile, for the equipment with gravity and elasticity as the sources of resistance, a special protection structure is required to provide a protection force in the same direction as a force generated by the person during exercise, so as to prevent injuries coming from the gravity and elasticity themselves caused by sudden force removal due to the conditions such as fatigue, injury or posture deformation during exercise, such as a protection rod on a bench press rack. However, in practice, in order to save the cost, the equipment adopted by a gymnasium or an individual is often not equipped with the protection structure, and the injuries caused by dropping of a barbell, and releasing and rebounding of a spring power twister often occur.

### TECHNICAL PROBLEMS

One of the objects of embodiments of the present application is to provide a damping mechanism providing constant resistance according to a preset value in variable movement states for an exercise system with fluid flow resistance as a source of resistance, and the exercise system which is safe and portable and has convenient and diversified use modes.

The fluid flow resistance is affected by various factors, such as a fluid flow cross section, a fluid flow velocity, fluid pressure, and the like. In an exercise scene, force application velocities and strength on the exercise equipment by human activities must be varied and diversified. Therefore, single regulation of the fluid flow cross section by adopting a mechanical means inevitably cannot ensure that the provided resistance is in a preset range.

### TECHNICAL SOLUTIONS

The technical solutions adopted in the embodiments of the present application are as follows:
in an exercise system, a fluid flow damping mechanism is used as a source of resistance, and an electric control valve is adopted to dynamically control a fluid flow cross section according to relevant factors such as a fluid flow velocity and pressure, so as to ensure that the exercise system may provide resistance stabilized at a preset value in different movement states.

In a first aspect, there is provided a damping mechanism providing resistance for an exercise system, connected between a first exercise component and a second exercise component which move relative to each other, and capable of providing resistance stabilized at a preset value in various movement states with different strength and velocities, wherein the damping mechanism includes:
a fixing portion connected to the first exercise component, the fixing portion having a chamber for accommodating a fluid;
a movable portion connected to the second exercise component, the movable portion being at least partially provided in the chamber and dividing the chamber into at least two fluid chambers, fluid volumes in the two fluid chambers having opposite variation trends, a fluid passage being connected between the two fluid chambers, and the movable portion being driven to move in the chamber when the first exercise component and the second exercise component move relative to each other to push the fluid to flow from one of the fluid chambers into the other fluid chamber through the fluid passage; and
at least one flow regulating valve capable of regulating a magnitude of fluid resistance in the fluid passage by adjusting a cross section of the fluid passage;
a pressure sensor used for acquiring pressure data of the fluid; and
a first processor used for receiving the preset value of the resistance and the pressure data varying in real time, obtaining a real-time control instruction of the flow regulating valve after comprehensive processing, and issuing the real-time control instruction to the flow regulating valve, so as to control the fluid resistance to be kept within a preset value range in different movement states by dynamically regulating the flow regulating valve.

In some embodiments, when a valve core assembly of the flow regulating valve regulates a cross-sectional size of the fluid passage, a cross-sectional shape where the fluid passage matches the flow regulating valve remains unvaried.

In some embodiments, the flow regulating valve includes a linear driving mechanism, a valve body and the valve core assembly capable of extending into the valve body, the valve body has the fluid passage, two ends of the fluid passage are respectively communicated with the two fluid chambers, the linear driving mechanism is connected to the valve core assembly and used for driving the valve core assembly to move linearly, and the linear driving mechanism is electrically connected to the first processor to control a cross section of a runner in the fluid passage through a position of the valve core assembly in the valve body, so as to regulate flow resistance.

In some embodiments, the linear driving mechanism includes a motor capable of outputting rotational movement, a first lead screw driven by the motor to rotate, and a first threaded sleeve connected to the first lead screw, the valve core assembly is fixedly connected to the first threaded sleeve, and a flow velocity in the fluid passage is controlled by controlling the number of turns of rotation of the first lead screw.

In some embodiments, two ends of the fluid passage respectively extend to be communicated with the two fluid chambers, so that the valve body is directly communicated with the fluid chambers; or the valve body is connected to the fluid chambers through fluid hoses, one end of the fluid hose is communicated with the fluid passage, and the other end thereof is communicated with the fluid chamber.

In some embodiments, the valve core assembly includes a plug driven by the linear driving mechanism and a volume-variable sealing structure, the valve body is provided with an extension opening through which the plug extends into the fluid passage, one end of the sealing structure is sealingly connected to the plug, the other end of the sealing structure is fixed to a periphery of the extension opening, the plug is provided inside the sealing structure, and a sealing chamber is formed between the sealing structure and the plug.

In some embodiments, the sealing structure includes a folding cylinder capable of being folded and unfolded and a fixing plate connected to one end of the folding cylinder, one end of the plug is fixed to the fixing plate, the other end of the plug is used for extending into the fluid passage, and one end of the folding cylinder away from the fixing plate is sealingly connected to the periphery of the extension opening.

In some embodiments, the plug is sealingly connected to the extension opening, and an outer peripheral wall of the plug is provided with a pressure relief groove for communicating the fluid passage and the sealing chamber.

In some embodiments, a sealing member is provided at the periphery of the extension opening, the plug includes a connecting section and a plugging section for extending into the fluid passage, the pressure relief groove is provided at the plugging section, a blocking step is formed at a junction of the connecting section and the plugging section, and the blocking step is used for compressing the sealing member.

In some embodiments, the movable portion includes a power push plate and a transmission assembly, the power push plate is provided between the two fluid chambers, the second exercise component is connected to a power input end of the transmission assembly, the power push plate is connected to a power output end of the transmission assembly, and the transmission assembly is used for outputting rotational movement of the second exercise component as linear movement of the power push plate.

In some embodiments, the transmission assembly includes a second lead screw and a second threaded sleeve, the second threaded sleeve is threadedly connected to the second lead screw, the second exercise component is fixedly connected to the second lead screw, and the power push plate is fixedly connected to the second threaded sleeve.

In some embodiments, a ratio of an axial length of the second threaded sleeve to a length of the second lead screw is less than 0.5, matching threads between the second threaded sleeve and the second lead screw are multi-start threads in a trapezoidal thread profile, the number of starts of the threads is 10 to 30, and a lead angle of the threads is 40 degrees to 60 degrees.

In some embodiments, the fixing portion includes two fluid driving structures, the fluid driving structures have the fluid chambers, the fluid driving structure includes a first end plate, a second end plate and a folding unit, two ends of the folding unit are respectively connected to the first end plate and the second end plate, the two second end plates are both fixedly connected to the power push plate, and two ends of the second lead screw are rotatably supported on the two first end plates.

In some embodiments, the folding unit is cylindrical, and the fluid chamber is formed by enclosure of the first end plate, the second end plate and an inner wall of the folding unit; or
the fixing portion further includes a housing structure, the folding unit, the transmission assembly and the power push plate are all positioned in the housing structure, the folding unit is cylindrical, and the fluid chamber is formed by enclosure of the first end plate, the second end plate, an inner wall of the housing structure and an outer wall of the folding structure.

In some embodiments, the damping mechanism further includes a second guide rod and a guide sleeve sleeved on the second guide rod, wherein two ends of the second guide rod are respectively fixed to the two first end plates, the second guide rod is parallel to the second lead screw, and the guide sleeve is fixedly connected to the power push plate.

In a second aspect, there is provided an exercise system, including at least one damping mechanism described above, at least one connecting assembly for implementing an exercise action, a communication module for communicative connection with a first mobile device, a pressure sensor for detecting fluid pressure, a control switch for regulating a direction and/or a magnitude of a preset resistance value, a first state display portion for displaying information of a first device, and a second processor for receiving and/or processing a real-time resistance numerical value obtained from fluid pressure information and displaying the real-time resistance numerical value on the first state display portion, wherein the connecting assembly includes a first exercise component and a second exercise component.

In some embodiments, the exercise system further includes a second mobile device, a Bluetooth module for connecting the second mobile device with the first processor, and a second state display portion for displaying information of a second device.

In some embodiments, the second mobile device further includes a movement state sensing apparatus for acquiring a movement state at a holding part of the connecting assembly, and the movement state sensing apparatus is capable of sending movement state information to the first processor and/or the first mobile device.

In some embodiments, the exercise system further includes a third state display portion and a third processor for comprehensively processing movement state information and/or resistance information to obtain measured exercise information and displaying the measured exercise information on the third state display portion, wherein the measured exercise information includes a degree of action completion and/or a degree of course completion.

In some embodiments, the exercise system further includes a memory for storing course information of at least one user and a plurality of pieces of measured exercise information of the user, wherein the third processor is capable of performing statistics on the plurality of pieces of measured exercise information of the at least one user to obtain a variation trend of the measured exercise information and displaying the variation trend on a fourth state display portion, and the fourth state display portion is provided on a mobile device.

### BENEFICIAL EFFECTS

A damping mechanism providing resistance for an exercise system, and the exercise system provided in embodiments of the present application have the following beneficial effects: the present application provides a damping mechanism providing constant resistance according to a preset value in variable movement states with fluid flow resistance as a source of resistance, and an exercise system which is safe and portable and has convenient and diversified use modes, wherein the exercise system uses the fluid resistance between the adjustable fluid chambers communicated with each other as a source of resistance, may provide resistance more than ten times of its own weight without active driving such as electric power, achieves electrically controlled regulation of the magnitude of the resistance with a minimal power simultaneously, so as to be convenient and safe, and does not rebound to endanger an exerciser and the surrounding environment and personnel even if a force is suddenly removed. Through the sampling and processing of the pressure of a circulating fluid at key positions, the real-time display and other processing of data such as a magnitude and a velocity of the force in an exercise process are achieved, the resistance of various magnitudes and directions is provided as needed under the matching of a mobile device and special software, and based on this premise, different exercise programs can be flexibly and smoothly integrated in a single course, so that various convenient customized courses are provided according to different needs and matches the user to smoothly complete the exercise action.

### BRIEF DESCRIPTION OF THE DRAWINGS

In order to explain the technical solutions in embodiments of the present application more clearly, a brief introduction of the accompanying drawings to be used in the embodiments or exemplary technical description will be given below. It is apparent that the drawings in the following description are only some embodiments of the present application, and for a person of ordinary skill in the art, other drawings may also be obtained according to these drawings without involving any inventive effort.

FIG. 1 is a perspective structural view of a first damping mechanism provided in an embodiment of the present application;

FIG. 2 is a cross-sectional view of the first damping mechanism provided in an embodiment of the present application;

FIG. 3 is a cross-sectional view of a second damping mechanism provided in an embodiment of the present application;

FIG. 4 is a perspective structural view of a first type of flow regulating valve provided in an embodiment of the present application;

FIG. 5 is a cross-sectional view of the flow regulating valve in FIG. 4;

FIG. 6 is a side view of a valve body of the flow regulating valve in FIG. 4;

FIG. 7 is a perspective structural view of a second type of flow regulating valve provided in an embodiment of the present application;

FIG. 8 is a cross-sectional view of the flow regulating valve in FIG. 7;

FIG. 9 is a perspective structural view of a plug of the flow regulating valve in FIG. 7;

FIG. 10 is a perspective structural view of a first type of exercise system provided in an embodiment of the present application;

FIG. 11 is a perspective structural view of a second type of exercise system provided in an embodiment of the present application;

FIG. 12 is a perspective structural view of a third type of exercise system provided in an embodiment of the present application; and

FIG. 13 is a perspective structural view of a fourth type of exercise system provided in an embodiment of the present application.

Wherein each reference numeral in the drawings is as follows:
100—damping mechanism; 1—fixing portion; 11—fluid driving structure; 110—fluid chamber; 111—first end plate; 112—folding unit; 12—housing structure; 13—cylindrical portion; 14—pressure sensor; 2—movable portion; 21—transmission assembly; 211—second lead screw; 212—second threaded sleeve; 213—second guide rod; 22—power push plate; 221—sealing ring; 222—compression ring; 3—flow regulating valve; 31—linear driving mechanism; 311—motor; 312—first lead screw; 313—first threaded sleeve; 314—first guide rod; 32—valve core assembly; 321—plug; 3211—connecting section; 3212—plugging section; 32120—pressure relief groove; 3213—blocking step; 322—sealing structure; 3221—folding cylinder; 3222—fixing plate; 3223—sealing chamber; 33—valve body; 330—extension opening; 331—fluid passage; 34—fluid hose; 341—first sensor; 342—second sensor; 343—first trigger piece; 344—second trigger piece; 35—sealing member; 36—sealing gasket; 37—fixing seat; 4—second mobile device;
200—first exercise component; 300—second exercise component; 400—exercise bottom plate structure; 500—connecting rod; 600—handlebar structure; and 700—vertical plate.

### DETAILED DESCRIPTION OF THE INVENTION

In order to make the objects, technical solutions and advantages of the present application more clear and apparent, the present application will be further described in more detail below in conjunction with the accompanying drawings and embodiments. It should be understood that the specific embodiments described herein are merely illustrative of the present application and are not intended to limit the present application.

It should be noted that when a component is referred to as being “fixed” or “provided” on another component, it may be directly on the other component or indirectly on the other component. When one component is referred to as being “connected” to another component, it may be directly or indirectly connected to the other component. The terms “upper”, “lower”, “left”, “right”, and the like indicate orientations or positional relationships based on the orientations or positional relationships shown in the drawings, which are merely used for convenience of description, do not indicate or imply that the referenced apparatus or element must have a particular orientation, or be constructed and operated in a particular orientation, and thus are not to be construed as limitations of the present application. For a person of ordinary skill in the art, the particular meaning of the above terms may be understood based on the specific circumstances. The terms “first” and “second” are only used for the purpose of facilitating description and are not to be construed as indicating or implying relative importance or implicitly indicating the number of technical features. “A plurality of” means two or more, unless definitely and specifically defined otherwise.

In order to explain the technical solutions provided in the present application, the following detailed description is made in conjunction with the specific drawings and embodiments.

Some embodiments of the present application provide a damping mechanism 100 which may provide resistance for an exercise system to assist an exercise person in completing some exercise actions requiring additional damping. The damping mechanism 100 is connected between a first exercise component 200 and a second exercise component 300, and relative movement may be generated between the first exercise component 200 and the second exercise component 300 under the driving of the exercise person, and the damping mechanism 100 provides resistance for the relative movement between the first exercise component 200 and the second exercise component 300.

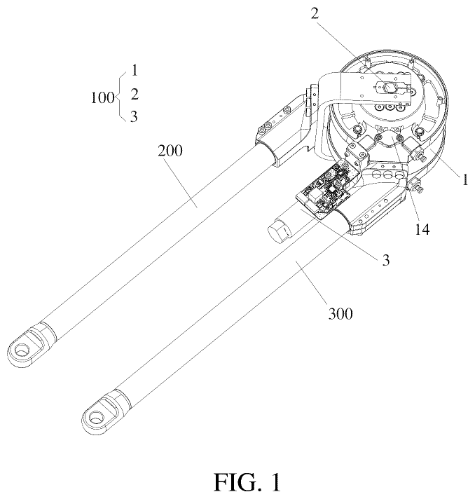

With reference to FIG. 1 to FIG. 3, the damping mechanism 100 includes a fixing portion 1, a movable portion 2, a flow regulating valve 3, a first processor, and a pressure sensor 14.

The first processor is used for receiving a preset value of the resistance and pressure data varying in real time, obtaining a real-time control instruction of the flow regulating valve 3 after comprehensive processing, and issuing the real-time control instruction to the flow regulating valve 3, so as to control fluid resistance to be kept within a preset value range in different movement states by dynamically regulating the flow regulating valve 3. The preset value of the resistance may be set on a first mobile device or the damping mechanism 100 in advance. The pressure data may be acquired from the pressure sensor 14, and the first processor is electrically connected to the pressure sensor 14. Therefore, a magnitude of the resistance, a direction of the resistance, and the like of the fluid may be controlled by the first processor, and the first processor may also feed back a state (a switching state, a magnitude of damping, a direction of the damping, and the like) of the damping mechanism 100, and the like to the first mobile device.

A mode of communicative connection between the first mobile device and the damping mechanism 100 may be wired connection or wireless connection. The first processor is connected to a control switch, and the first processor is used for receiving a preset resistance value set by the control switch. Specifically, the resistance data acquired by the pressure sensor 14 may be transmitted to the first processor, and the first processor receives the fluid pressure data detected by the pressure sensor 14 and regulates the flow regulating valve 4 according to the fluid pressure data and a state of the control switch, so as to achieve the regulation of the fluid resistance and the switching of the flow regulating valve 4. Or, the resistance data acquired by the pressure sensor 14 may be transmitted to the first processor and then the resistance data is transmitted to the mobile device, the mobile device may issue control data to the first processor according to the resistance data, and the first processor performs control and regulation on the flow regulating valve 3, the movable portion 2, and the like according to relevant control data, wherein the control data of the first mobile device may include increasing the resistance, decreasing the resistance, varying a movement direction of the fluid, and the like.

The pressure sensor 14 may be provided inside a fluid passage 331 to detect the fluid resistance more directly.

The pressure sensor 14 is an instrument or apparatus capable of sensing a pressure signal and converting the pressure signal into a usable output electric signal according to a certain rule.

The pressure sensor 14 is electrically connected to the first processor, and the pressure sensor is used for acquiring the pressure data of the fluid.

The fixing portion 1 is connected to the first exercise component 200, the fixing portion 1 and the first exercise component 200 may be fixedly provided simultaneously, the fixing portion 1 may also move synchronously with the first exercise component 200, and the fixing portion 1 has a chamber for accommodating the fluid, wherein the fluid may be a substance capable of flowing, such as a gas and a liquid.

The movable portion 2 is connected to the second exercise component 300, at least part of a structure of the movable portion 2 may move synchronously with the second exercise component 300, and when the second exercise component 300 moves, the movable portion 2 may be driven to move. The movable portion 2 is at least partially provided inside the chamber, the movable portion 2 may divide the chamber to form two fluid chambers 110, and the two fluid chambers 110 are communicated with each other through the fluid passage 331. The fluid in one of the fluid chambers 110 may move towards the other fluid chamber 110, and it may also be understood as: the fluid in one of the fluid chambers 110 is increased and the fluid in the other fluid chamber 110 is decreased. The fluid in the two fluid chambers 110 shifts, namely, a total volume of the fluid in the chambers is constant, but fluid volumes in the two fluid chambers 110 have opposite variation trends, and the amount of the fluid increased in one of the fluid chambers 110 is equal to the amount of the fluid correspondingly decreased from the other fluid chamber 110, wherein the fluid chamber 110 may be a flexible chamber whose volume can be varied according to the volume variation of the fluid therein. The volume of the fluid chamber 110 is increased when the fluid flows into the fluid chamber 110, and the volume of the fluid chamber 110 is decreased when the fluid flows out of the fluid chamber 110.

Therefore, when the total volume of the fluid in the chambers is constant, the variation trends of the volumes of the two fluid chambers 110 is opposite, the volume of one of the fluid chambers 110 is increased with the inflow of the fluid, and the volume of the other fluid chamber 110 is decreased with the outflow of the fluid.

The relative movement between the first exercise component 200 and the second exercise component 300 may provide a driving force for the flow of the fluid in the chambers, and when the fluid flows, viscous resistance of the fluid may provide resistance for the relative movement between the first exercise component 200 and the second exercise component 300. Specifically, when the first exercise component 200 and the second exercise component 300 move relative to each other, the movable portion 2 and the fixing portion 1 may move relative to each other, thereby driving the movable portion 2 to move in the chamber, varying the sizes of the volumes of the two fluid chambers 110, and then varying the corresponding fluid volumes in the two fluid chambers 110, so that the fluid in one of the fluid chambers 110 flows into the other fluid chamber 110 through the fluid passage 331. When the relative movement between the first exercise component 200 and the second exercise component 300 is stopped, the relative movement between the movable portion 2 and the fixing portion 1 is also stopped, and the movement of the fluid is also correspondingly stopped, so that the same kind of dangers such as gravity falling and elasticity rebounding may not be caused, and the safety of the exercise system may be improved.

The number of the flow regulating valves 3 is at least one, and the flow regulating valve 3 is used for regulating a cross-sectional area of the fluid passage 331, so that a magnitude of fluid resistance when the fluid flows between the two fluid chambers 110 may be regulated. The smaller the cross-sectional area of the fluid passage 331 is, the larger the fluid resistance is, and the larger the cross-sectional area of the fluid passage 331 is, the smaller the fluid resistance is.

The flow regulating valve 3 is electrically connected to the first processor, and the first processor can regulate the magnitude of the fluid resistance and the direction of the fluid flow. Specifically, the first processor can control a cross-sectional size of the fluid passage 331 through the flow regulating valve 3, thereby regulating the magnitude of the fluid resistance. The first processor can vary the volumes of the two fluid chambers 110 by controlling a movement direction of the movable portion 2, so that the direction of fluid flow may be controlled.

In some embodiments, the pressure sensor 14 is provided inside the fluid passage 331 to detect the fluid resistance more directly.

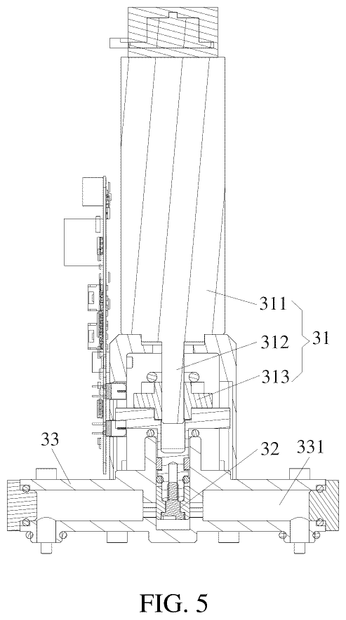

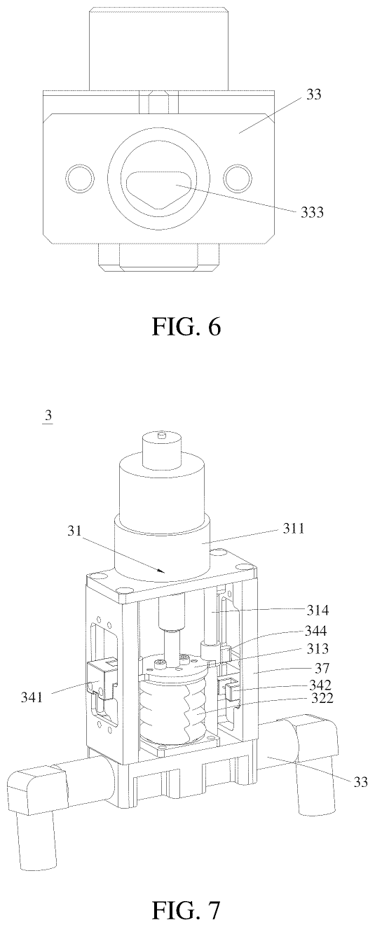

In some embodiments of the present application, with reference to FIG. 5 and FIG. 6, when a valve core assembly 32 of the flow regulating valve moves, a cross-sectional size of the fluid passage 331 may be regulated, and the cross-sectional size of the fluid passage 331 is varied, with a corresponding variation in the fluid resistance. When the valve core assembly 32 of the flow regulating valve 3 regulates the cross-sectional size of the fluid passage 331, a cross-sectional shape where the fluid passage 331 matches the flow regulating valve 3 remains unvaried. Since the magnitude of the fluid resistance is related to the cross-sectional size, when the cross-sectional shape remains unvaried in a variation process of the cross-sectional size, a variation relationship between the cross-sectional area and the fluid resistance is more stable, and it is easier to control the fluid resistance by the variation of the cross-sectional area.

In some embodiments, the cross-sectional shape where the fluid passage 331 matches the flow regulating valve 3 is triangular, trapezoidal, and the like, and when the cross-sectional size of the fluid passage 331 is regulated, the cross-sectional shape thereof is always maintained to be triangular, trapezoidal, and the like, namely, the shape is always constant and the size is varied.

In some embodiments, a cross section of the fluid passage 331 is triangular. When the cross-sectional size of the fluid passage 331 is regulated, the valve core assembly 32 of the flow regulating valve 3 gradually moves from a bottom side of the triangle towards an apex thereof, so that the cross section is always maintained to be triangular.

In some embodiments, the cross section of the fluid passage 331 is trapezoidal. When the cross-sectional size of the fluid passage 331 is regulated, the valve core assembly 32 of the flow regulating valve 3 gradually moves from a bottom edge of the trapezoid towards a top edge thereof, so that the cross section is always maintained to be trapezoidal.

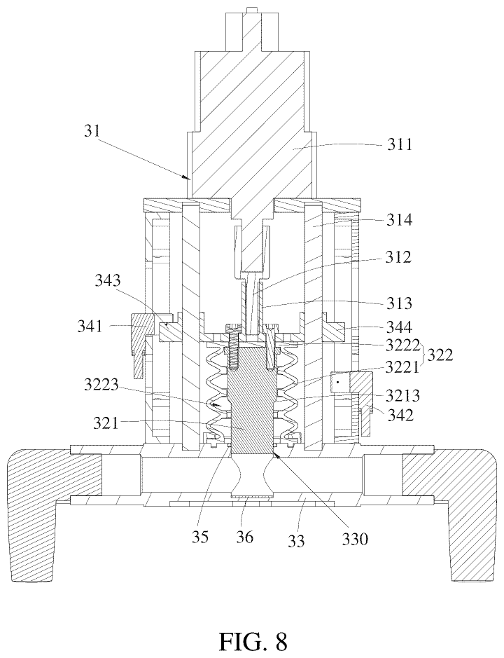

In some embodiments of the present application, with reference to FIG. 5, FIG. 7 and FIG. 8, the flow regulating valve 3 includes a linear driving mechanism 31, a valve body 33 and the valve core assembly 32. The valve body 33 may be connected to the fixing portion 1, the valve body 33 is provided with the fluid passage 331 for allowing the fluid to pass through the interior of the valve body 33, and two ends of the fluid passage 331 are respectively communicated with the two fluid chambers 110, so that when the fluid between the two fluid chambers 110 flows back and forth, the fluid passes through the fluid passage 331 of the flow regulating valve 3, and the flow regulating valve 3 can regulate the magnitude of the fluid resistance.

The valve core assembly 32 can extend into the interior of the valve body 33 to vary the size of the fluid passage 331, the valve core assembly 32 is driven by the linear driving mechanism 31, a movement output end of the linear driving mechanism 31 is fixedly connected to the valve core assembly 32, and the linear driving mechanism 31 can output linear movement, so as to drive the valve core assembly 32 to generate linear movement to control the fluid resistance. A relationship between the valve core assembly 32 and the fluid resistance is more easily determined when the valve core assembly 32 moves linearly, and a movement distance of the valve core assembly 32 required is more easily calculated when the fluid resistance is required to be regulated to a predetermined numerical value.

Wherein the linear driving mechanism 31 is electrically connected to the first processor, and a cross section of a runner of the fluid in the fluid passage 331 is controlled through a position of the valve core assembly 32 in the valve body 33, so as to regulate the flow resistance. The first processor transmits control data to the linear driving mechanism 31, so that the movement of the linear driving mechanism 31 may be controlled to vary the position of the valve core assembly 32, so as to vary a flow velocity of the fluid in the fluid passage 331.

In some embodiments of the present application, with reference to FIG. 5, two ends of the fluid passage 331 respectively extend to be communicated with the two fluid chambers 110, so that the valve body 33 is directly connected to the fluid chambers 110. Specifically, the fluid passage 331 is completely embedded in the valve body 33 of the flow regulating valve 3, and two ends of the valve body 33 (the two ends of the fluid passage 331) are directly connected and fixed to an outer wall of the fluid chamber 110, so that the connection between the flow regulating valve 3 and the fluid chamber 110 does not require the use of a fluid hose 34, and the structural reliability thereof is higher.

In some embodiments of the present application, with reference to FIG. 7 and FIG. 8, the valve body 33 is connected to the fluid chambers 110 through fluid hoses 34, the two ends of the fluid passage 331 in the valve body 33 are both connected to the fluid hoses 34, and one end of the fluid hose 34 away from the valve body 33 is communicated with the corresponding fluid chamber 110, so that the two fluid chambers 110 are communicated with each other through the flow regulating valve 3. In this embodiment, the position of the flow regulating valve 3 may not be restricted and does not need to be provided close to the fluid chamber 110.

In some embodiments of the present application, with reference to FIG. 5, FIG. 7 and FIG. 8, the linear driving mechanism 31 includes a motor 311, a first lead screw 312 and a first threaded sleeve 313. The first screw rod 312 is fixedly connected to a movement output end of the motor 311, and the first threaded sleeve 313 is threadedly connected to the first screw rod 312. The motor 311 can output rotational movement to rotate the first lead screw 312, the first threaded sleeve 313 moves along a length direction of the first lead screw 312, and the first threaded sleeve 313 is fixedly connected to the valve core assembly 32. In this way, when the motor 311 is operated, the valve core assembly 32 may move linearly. Thus, by controlling the number of turns of rotation of the motor 311 by the first processor, the number of turns of rotation of the first lead screw 312 may be controlled, thereby controlling the flow velocity in the fluid passage 331 and then controlling the fluid resistance.

In other embodiments, the linear driving mechanism 31 may also be an air cylinder capable of outputting linear movement, a rack-and-pinion mechanism, and the like.

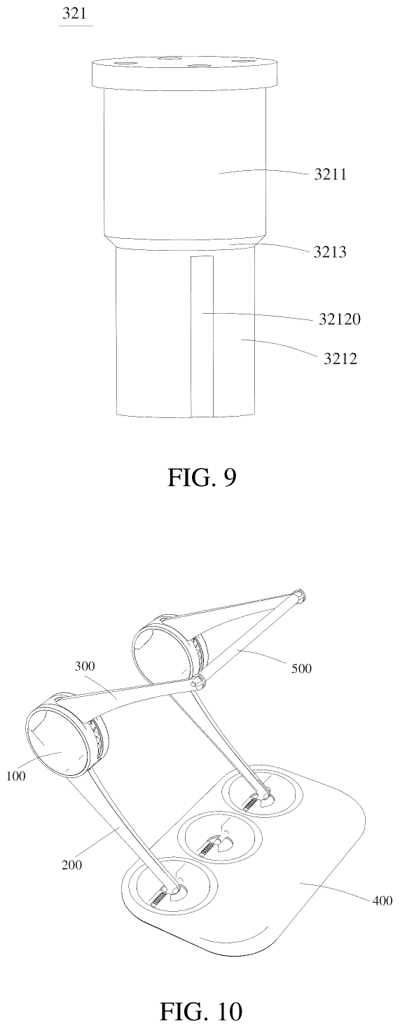

In some embodiments of the present application, with reference to FIG. 7 and FIG. 9, the valve core assembly 32 includes a plug 321 and a sealing structure 322. The linear driving mechanism 31 can output linear movement, and the plug 321 is driven by a second linear driving mechanism 31 and can perform linear reciprocating movement. The valve body 33 is provided with an extension opening 330 through which the plug 321 extends into the fluid passage 331, and the plug 321 can pass through the extension opening 330 to enter the interior of the fluid passage 331. When the plug 321 does not extend into the fluid passage 331, the fluid passage 331 is not blocked, and the flow regulating valve 3 is completely opened; the longer the plug 321 extends, the smaller the fluid passage 331 is, and the smaller the flow is; and after the plug 321 completely extends into the fluid passage 331, the fluid passage 331 may be completely blocked, and the flow regulating valve 3 is closed. A pressure relief channel is provided between an outer wall of the plug 321 and an inner wall of the extension opening 330, the plug 321 is provided inside the sealing structure 322, the plug 321 is fixedly connected to a first end of the sealing structure 322, the other end of the sealing structure 322 is fixed to a periphery of the extension opening 330, a volume of the sealing structure 322 may be increased or decreased, for example, may be stretched or compressed, and one end of the sealing structure 322 is sealingly connected to the plug 321 and moves with the movement of the plug 321, thereby generating stretching or compression. A sealing chamber 3223 is formed between the sealing structure 322 and the plug 321, and the sealing chamber 3223 is communicated with the fluid passage 331. In this way, when the plug 321 moves at a high frequency, the pressure in the fluid passage 331 may be larger, and the fluid may enter the sealing chamber 3223 through a gap between the plug 321 and the extension opening 330, thereby preventing the fluid from leaking, wherein the fluid may be a gas, a liquid, and the like.

In one embodiment of the present application, with reference to FIG. 8, the plug 321 is sealingly connected to the extension opening 330, and an outer peripheral wall of the plug 321 is provided with a pressure relief groove 32120, and the liquid in the fluid passage 331 can only flow out from the pressure relief groove 32120 to the sealing chamber 3223. When the pressure in the fluid passage 331 is excessive, the fluid in the fluid passage 331 may enter the sealing chamber 3223 through the pressure relief groove 32120, so as to relieve the pressure in the fluid passage 331, avoid excessive impact on the plug 321, and also prevent the fluid from leaking, wherein the pressure relief groove 32120 may be provided to extend to one end of the plug 321 for extending into the fluid passage 331, so that when the end of the plug 321 is close to the extension opening 330, the end cannot be completely blocked by an inner wall of the extension opening 330, and the fluid can still enter the sealing chamber 3223 through the pressure relief groove 32120.

Optionally, with reference to FIG. 9, the pressure relief groove 32120 has a straight bar shape, and a length direction thereof is the same as a movement direction of the plug 321, namely, the pressure relief groove 32120 is provided to extend along the movement direction of the plug 321. The number of the pressure relief grooves 32120 is multiple, and the pressure relief grooves 32120 are sequentially provided at the periphery of the plug 321 at intervals. In this embodiment, the plug 321 may have a cylindrical shape, an elliptical cylindrical shape, an elongated shape, and the like.

Optionally, the pressure relief groove 32120 extends in a spiral shape and is spirally provided on the outer peripheral wall of the plug 321. Accordingly, the plug 321 is cylindrical with a circular cross section. The number of the pressure relief grooves 32120 may be multiple, and adjacent pressure relief grooves 32120 are provided at intervals.

In one embodiment of the present application, with reference to FIG. 8, a sealing member 35 is provided at the periphery of the extension opening 330, and when the plug 321 extends into the fluid passage 331 to completely block the fluid passage 331, the sealing member 35 matches the plug 321 to completely seal the extension opening 330 of the fluid passage 331, so that the flow regulating valve 3 is in a closed state, wherein the periphery of the extension opening 330 may be provided with an annular groove for accommodating the sealing member 35, and the sealing member 35 is provided facing the interior of the sealing chamber 3223 and may match a blocking step 3213 described below in a pressing manner.

Specifically, with reference to FIG. 8 and FIG. 9, the plug 321 includes a connecting section 3211 and a plugging section 3212, wherein one end of the connecting section 3211 is fixedly connected to the sealing structure 322, the other end of the connecting section 3211 is fixedly connected to the plugging section 3212, and the plugging section 3212 is used for extending into the interior of the fluid passage 331. The blocking step 3213 is formed at a junction of the connecting section 3211 and the plugging section 3212, and when the blocking step 3213 of the plug 321 moves to be close to the extension opening 330, the blocking step 3213 presses the sealing member 35, so that the fluid passage 331 is in a sealed state at the extension opening 330. Furthermore, the pressure relief groove 32120 is provided at the plugging section 3212, and when the blocking step 3213 presses the sealing member 35, the pressure relief groove 32120 is completely positioned in the fluid passage 331, and the pressure relief groove 32120 cannot be communicated to the sealing chamber 3223, namely, the fluid passage 331 is completely sealed at the extension opening 330, so that the flow regulating valve 3 is closed.

Wherein a cross-sectional area of the connecting section 3211 is greater than a cross-sectional area of the plugging section 3212. When a cross section of the plug 321 is circular, a diameter of the connecting section 3211 is greater than a diameter of the plugging section 3212; and when the cross section of the plug 321 is square, a side length of the connecting section 3211 is greater than a side length of the plugging section 3212.

Optionally, the blocking step 3213 is obliquely provided with respect to the cross section of the plug 321, so that firstly the blocking step 3213 is easier to machine, and secondly after the plug 321 contacts with the sealing member 35, there is a longer buffer stroke to prevent the sealing member 35 from being excessively pressed.

In another embodiment of the present application, there is a gap between the outer peripheral wall of the plug 321 and an inner peripheral wall of the extension opening 330, the gap is the pressure relief channel for communicating the fluid passage 331 and the sealing chamber 3223, and the fluid in the fluid passage 331 may enter the sealing chamber 3223 through the pressure relief channel.

In one embodiment of the present application, with reference to FIG. 8, the fluid passage 331 is provided with a sealing gasket 36 at a position directly opposite to the extension opening 330, and after the plug 321 completely enters the fluid passage 331, the end of the plug 321 contacts with the sealing gasket 36 and presses the sealing gasket 36, so that the fluid passage 331 in the fluid passage 331 is completely closed. The fluid passage 331 may be provided with a receiving groove at the sealing gasket 36, and the sealing gasket 36 is provided in the receiving groove.

Or, the sealing gasket 36 is provided at one end of the plug 321 for extending into the fluid passage 331, and after the plug 321 completely enters the fluid passage 331, the plug 321 and an inner wall of the fluid passage 331 press the sealing gasket 36 against each other, so that the fluid passage 331 in the fluid passage 331 is completely closed.

In one embodiment of the present application, with reference to FIG. 8, the sealing structure 322 includes a folding cylinder 3221 and a fixing plate 3222, wherein the fixing plate 3222 is connected to one end of the folding cylinder 3221, one end of the folding cylinder 3221 is blocked by the fixing plate 3222, the other end of the folding cylinder 3221 is provided to be open, and the open end of the folding cylinder 3221 is fixed at the periphery of the extension opening 330. The folding cylinder 3221 may be folded or unfolded, the folding cylinder 3221 is in a contracted state when being folded, and the folding cylinder 3221 is in a stretched state when being unfolded. The provision of the folding cylinder 3221 allows the sealing structure 322 to be contracted or stretched with the movement of the plug 321. One end of the plug 321 is fixed to the fixing plate 3222, and the other end of the plug 321 extends into the interior of the fluid passage 331.

In other embodiments, the sealing structure 322 may also be a structure capable of being expanded or contracted, such as a balloon.

In some embodiments of the present application, the flow regulating valve 3 further includes a first guide rod 314, wherein the first guide rod 314 is provided in a first threaded sleeve 313 in a penetrating manner, and the first guide rod 314 and the first screw rod 312 are parallel to each other. When the first screw rod 312 rotates, the first threaded sleeve 313 moves along a length direction of the first screw rod 312, and under the guide action of the first guide rod 314, the first threaded sleeve 313 can be prevented from rotating circumferentially and can be ensured to smoothly move linearly. The plug 321 is fixedly connected to the first threaded sleeve 313, and when the first threaded sleeve 313 translates, the plug 321 also moves synchronously therewith. Thus, when the motor 311 is operated, the plug 321 may move back and forth along the length direction of the first lead screw 312.

Wherein the number of the first guide rods 314 may be selected to be multiple, the number of guide holes in the first threaded sleeve 313 is the same as the number of the first guide rods 314, and the first guide rods 314 are provided to pass through the corresponding guide holes. The first guide rods 314 are provided around the first lead screw 312. For example, the number of the first guide rods 314 is two, and the first guide rods 314 are respectively provided on two sides of the first lead screw 312; or, the number of the first guide rods 314 is four, and the first guide rods 314 are circumferentially provided at the periphery of the first lead screw 312.

Optionally, the fixing plate 3222 of the sealing structure 322 is sandwiched between the first threaded sleeve 313 and the plug 321, and the first threaded sleeve 313 and the plug 321 may be fixedly connected by a fixing member such as a threaded member.

In one embodiment of the present application, with reference to FIG. 7 and FIG. 8, the flow regulating valve 3 further includes a fixing seat 37 on which both the linear driving mechanism 31 and the valve body 33 are provided. A first sensor 341 and a second sensor 342 are further provided on the fixing seat 37, and the first sensor 341 and the second sensor 342 are respectively provided at two ends of a stroke of the plug 321 for detecting whether the plug 321 reaches a first limit position and a second limit position. Specifically, in conjunction with FIG. 8, the first limit position is a highest point of the plug 321, and when the plug 321 is at the first limit position, the passage of the fluid passage 331 is completely opened; and the second limit position is a lowest point of the plug 321, and when the plug 321 is at the second limit position, the passage of the fluid passage 331 is completely closed, wherein the first threaded sleeve 313 may be provided with a first trigger piece 343 and a second trigger piece 344, the first trigger piece 343 is used for triggering the first sensor 341, and the second trigger piece 344 is used for triggering the second sensor 342. The first sensor 341 and the second sensor 342 may be both photoelectric sensors.

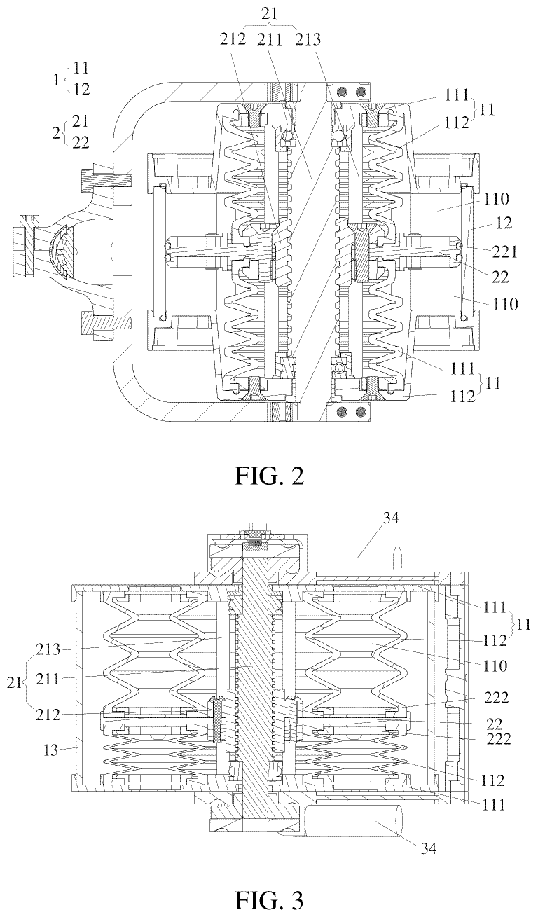

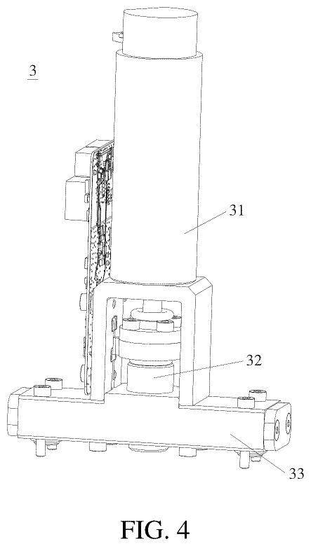

In some embodiments of the present application, with reference to FIG. 2 and FIG. 3, the movable portion 2 includes a power push plate 22 and a transmission assembly 21. The power push plate 22 is provided inside the chamber and positioned between the two fluid chambers 110. The movement of the power push plate 22 may vary the volumes of the two fluid chambers 110, thereby driving the fluid to flow from one of the fluid chambers 110 towards the other fluid chamber 110. The second exercise component 300 is connected to a power input end of the transmission assembly 21, the power push plate 22 is connected to a power output end of the transmission assembly 21, and the transmission assembly 21 is used for outputting rotational movement of the second exercise component 300 as linear movement of the power push plate 22.

The second exercise component 300 rotates relative to the first exercise component 200, the second exercise component 300 drives the transmission assembly 21 to move, and the transmission assembly 21 converts the second exercise component 300 into linear movement of the power push plate 22, thereby increasing the volume of one of the fluid chambers 110 and decreasing the volume of the other fluid chamber 110.

By providing the transmission assembly 21 and the power push plate 22, it is possible to convert the rotational movement into linear movement of the power push plate 22, so that the volumes of the two fluid chambers 110 may be varied.

In some embodiments of the present application, with reference to FIG. 2 and FIG. 3, the transmission assembly 21 includes a second lead screw 211 and a second threaded sleeve 212, wherein the second threaded sleeve 212 is threadedly connected to the second lead screw 211, the second lead screw 211 is the power input end of the transmission assembly 21, and the second threaded sleeve 212 is the power output end of the transmission assembly 21. Specifically, the second exercise component 300 is fixedly connected to the second lead screw 211, when the second exercise component 300 rotates, the second lead screw 211 is driven to rotate synchronously, the rotation of the second lead screw 211 enables the second threaded sleeve 212 move linearly, the second threaded sleeve 212 is fixedly connected to the power push plate 22, and the power push plate 22 also moves linearly with the second threaded sleeve 212. Thus, when an exercise person moves the second exercise component 300 relative to the first exercise component 200, the power push plate 22 moves linearly, one of the fluid chambers 110 is stretched as the volume becomes larger, and the other fluid chamber 110 is compressed as the volume becomes smaller, and it is necessary to act against the fluid resistance.

Optionally, the power push plate 22 is integrally formed with the second threaded sleeve 212, or separately formed and then fixedly connected to each other. The power push plate 22 is provided at one axial end of the second threaded sleeve 212.

Optionally, matching threads between the second threaded sleeve 212 and the second lead screw 211 may be multi-start threads in a trapezoidal thread profile. A lead angle of the threads is 40 degrees to 60 degrees, optionally the lead angle of the threads is 45 degrees to 58 degrees, and further the lead angle of the threads is 52±4 degrees, such as 52 degrees, 52.56 degrees, 56 degrees, and the like. A ratio of an axial length of the second threaded sleeve 212 to a length of the second lead screw is less than 0.5, and further the ratio of the axial length of the second threaded sleeve 212 to the length of the second lead screw is less than 0.35. In this embodiment, the transmission connection between the first threaded sleeve 212 and the second lead screw 211 may be more stable.

In other embodiments, the transmission assembly 21 includes a second lead screw 211, a second threaded sleeve 212 and a gear set, wherein the gear set may have a transmission ratio greater than 1 or less than 1, a driving gear of the gear set is fixedly connected to the second exercise component 300, and a driven gear of the gear set is fixedly connected to the second lead screw 211. A ratio of rotational speeds of the second exercise component 300 and the second lead screw 211 may be varied by providing the gear set.

In other embodiments, the transmission assembly 21 includes a gear and a rack, wherein the gear is the power input end of the transmission assembly 21 and is fixedly connected to the second exercise component 300, and the rack is the power output end of the transmission assembly 21 and is fixedly connected to the power push plate 22. The power push plate 22 may also move linearly when the second exercise component 300 drives the gear to rotate.

In some embodiments of the present application, with reference to FIG. 2 and FIG. 3, the fixing portion 1 includes two fluid driving structures 11, wherein the two fluid driving structures 11 are connected by the power push plate 22. The fluid driving structures 11 have the fluid chambers 110, and the fluid driving structure 11 includes a first end plate 111, a second end plate and a folding unit 112. Two ends of the folding unit 112 are respectively connected to the first end plate 111 and the second end plate, and the first end plate 111, the second end plate and the power push plate 22 may be provided in parallel. When the volume of the fluid driving structure 11 is increased, the folding unit 112 is gradually unfolded, and a distance between the first end plate 111 and the second end plate is gradually increased; and when the volume of the fluid driving structure 11 is decreased, the folding unit 112 is gradually folded, and the distance between the first end plate 111 and the second end plate is gradually decreased.

Wherein the second end plates of the two fluid driving structures 11 are both fixedly connected to the power push plate 22, and it may also be considered that the second end plates of the two fluid driving structures 11 are the power push plates 22. Two ends of the second lead screw 211 are rotatably supported on the two first end plates 111, wherein bearings are provided on the two first end plates 111, and two ends of the second lead screw 211 are respectively supported on the corresponding first end plates 111 through the two bearings, so that the second lead screw 211 can rotate smoothly.

In some embodiments of the present application, with reference to FIG. 2, the damping mechanism 100 further includes a housing structure 12 in which the folding unit 112, the transmission assembly 21, the power push plate 22, and the like are all positioned. In the same fluid driving structure 11, the number of the folding unit 112 is one, the folding unit 112 is cylindrical, and the fluid chamber 110 is formed by enclosure of the outer peripheral wall of the folding unit 112, the first end plate 111, the second end plate and an inner peripheral wall of the housing structure 12, wherein in order to ensure the sealability of the fluid chamber 110, a sealing structure 322 such as a sealing ring 221 is provided between the outer peripheral wall of the second end plate (the power push plate 22) and the inner peripheral wall of the housing structure 12, so as to ensure the sealability of the fluid chamber 110. In this embodiment, on the premise of not varying an effective movement stroke of the power push plate 22, by providing a shorter outer wall height from two ends relative to the inner wall, the ineffective fluid volume (the part which cannot flow between the two fluid chambers 110) is reduced, the overall volume and weight are reduced, and in other words, the effective utilization of the volume is improved, wherein the ineffective fluid volume depends on a compression ratio of muscle in an axial direction, the larger the compression ratio of the muscle is, the smaller the ineffective fluid volume is; and the ineffective fluid volume depends on a cross-sectional area of an accommodating chamber in a radial direction, the smaller the cross-sectional area of the accommodating chamber is, the smaller the ineffective fluid volume is.

Optionally, an opening of the fluid chamber 110 is provided in an axial end of the housing structure 12, namely, the flow regulating valve 3 is communicated to the axial end of the housing structure 12, so that the opening of the fluid chamber 110 does not need to be provided in a circumferential wall of the housing structure 12, and an axial length of the housing structure 12 may be an effective length as much as possible (suitable for the stretching and contraction of the fluid chamber 110), thereby enabling the structure to be more compact.

Optionally, for obtaining better structural strength and stability as well as a compact overall structure, the fluid passage 331 is provided in a rigid structure tightly clung to an outer side of the fluid chamber 110.

In some embodiments of the present application, with reference to FIG. 3, the folding unit 112 is cylindrical, and the fluid chamber 110 is formed by enclosure of the first end plate 111, the second end plate and the inner wall of the folding unit 112. In this embodiment, the fixing portion 1 includes a cylindrical portion 13, and the two folding units 112, the power push plate 22 and the transmission assembly 21 are all provided inside the cylindrical portion 13. During exercise of an exercise person, the exercise person may hold the first exercise component 200 by one hand and hold the second exercise component 300 by one hand to achieve the purpose of exercise by moving the second exercise component 300, wherein the first exercise component 200 may be fixedly connected to the cylindrical portion 13.

In some embodiments of the present application, with reference to FIG. 3, the ends of the folding unit 112 are fixed to the first end plate 111 and the second end plate by compression rings 222. The description is made by taking the two second end plates as the power push plates 22 for an example. One end of the folding unit 112 is sandwiched between the compression ring 222 and the first end plate 111, the end of the folding unit 112 is fixedly connected to the first end plate 111 by a connector such as a screw, the other end of the folding unit 112 is sandwiched between the power push plate 22 and the compression ring 222, and the end of the folding unit 112 is fixed to the power push plate 22 by the connector such as the screw.

In some embodiments of the present application, with reference to FIG. 3, in the same fluid driving structure 11, the number of folding units 112 is two, and one of the folding units 112 is sleeved on an outer circumference of the other folding unit 112. The fluid chamber 110 for accommodating the fluid is provided between the two folding units 112, and two ends of the fluid chamber 110 are respectively blocked by the first end plate 111 and the second end plate. Namely, the fluid chamber 110 of the fluid driving structure 11 is formed by enclosure of the first end plate 111, the second end plate and the folding unit 112. In this embodiment, the second lead screw 211 may be provided to pass through the internal folding unit 112, so that the space occupied by the folding unit 112 may be fully utilized, thereby enabling the structure of the damping structure to be more compact.

In other embodiments, in the same fluid driving structure 11, the number of the folding unit 112 is one, and the accommodating chamber of the fluid driving structure 11 is formed by enclosure of the inner peripheral wall of the folding unit 112, the first end plate 111 and the second end plate.

In other embodiments, the fluid driving structure 11 may also be a hydraulic cylinder.

In some embodiments of the present application, the damping structure further includes a guide structure for guiding the power push plate 22, so as to enable the movement of the power push plate 22 to be smoother without the phenomenon of being oblique towards one side during movement.

Wherein the guide structure includes a second guide rod 213 and a guide sleeve, wherein two ends of the second guide rod 213 are respectively fixed to the two first end plates 111, the second guide rod 213 and the second lead screw 211 are parallel to each other, the guide sleeve is fixedly connected to the power push plate 22, and when the power push plate 22 moves, the guide sleeve slides on the guide rod 213 along a length direction of the second guide rod 213, so that the power push plate 22 may be prevented from being oblique towards one side, and the linear movement of the power push plate 22 may be ensured. The guide sleeve may be integrally formed with the power push plate 22, the power push plate 22 is provided with a guide hole through which the second guide rod 213 passes, and the guide sleeve may be formed. The number of the guide structures is multiple, the guide structures may be provided around the periphery of the folding unit 112 or around the periphery of the second lead screw 211. The particular layout and number of the guide structures are not limited herein.

In some embodiments, with reference to FIG. 2, the number of the second guide rods 213 is multiple, two ends of some of the second guide rods 213 are fixedly connected to the two first end plates 111 respectively and provided to pass through the power push plate 22, and two ends of some of the second guide rods 213 are fixedly connected to two axial ends of the housing structure 12 respectively. Since the two axial ends of the housing structure 12 and the corresponding first end plates 111 are not in one plane, the lengths of the guide rods connected to the housing structure 12 and the first end plates 111 are also different, so that the movement of the power push plate 22 may be more stable.

In some embodiments of the present application, the second lead screw 211 is provided to be hollow, so as to reduce the weight of the damping structure, save raw materials and reduce the production cost. The second lead screw 211 may also have a solid structure.

In some embodiments of the present application, with reference to FIG. 2, the damping mechanism 100 further includes fixing pins, wherein two ends of the fixing pins are respectively fixed to the two first end plates 111, and the fixing pins are provided to pass through the power push plate 22. The number of the fixing pins is multiple, and the fixing pins may be provided around the second lead screw 211. The function of the fixed pins is to enhance the structural stability of the damping mechanism 100 and prevent the structure such as the power push plate 22 from rotating when the lead screw rotates.

The present application further provides an exercise system which includes at least one damping mechanism 100 in any one of the embodiments described above. In the exercise system, the damping mechanism 100 uses the fluid resistance between the adjustable fluid chambers 110 communicated with each other as a source of resistance, may provide resistance more than ten times of its own weight without active driving such as electric power, achieves electrically controlled regulation of the magnitude of the resistance with a minimal power simultaneously, so as to be convenient and safe, and does not rebound to endanger an exerciser and the surrounding environment and personnel even if a force is suddenly removed. Through the sampling and processing of the pressure of a circulating fluid at key positions, the real-time display and other processing of data such as a magnitude and a velocity of the force in an exercise process are achieved, the resistance of various magnitudes and directions is provided as needed under the matching of a mobile device and special software, and based on this premise, different exercise programs can be flexibly and smoothly integrated in a single course, so as to provide convenient customized courses for various people with different needs.

In some embodiments of the present application, the exercise system further includes at least one connecting assembly for implementing an exercise action, a communication module for communicative connection with a first mobile device, a pressure sensor 14 for detecting fluid pressure, a control switch for regulating a direction and/or a magnitude of a preset resistance value, a first state display portion for displaying information of a first device, and a second processor for receiving and/or processing a real-time resistance numerical value obtained from fluid pressure information and displaying the real-time resistance numerical value on the first state display portion, wherein the connecting assembly includes the first exercise component 200 and the second exercise component 300.

In some embodiments, with reference to FIG. 1, the connecting assembly at least includes the first exercise component 200 and the second exercise component 300, wherein the first exercise component 200 is connected to the fixing portion 1 of the damping mechanism 100, and the second exercise component 300 is connected to the movable portion 2 of the damping mechanism 100. The second exercise component 300 can move relative to the first exercise component 200, for example, the second exercise component 300 can rotate relative to the first exercise component 200.

Optionally, with reference to FIG. 1, the flow regulating valve 3 is provided close to the first exercise component 200, when the second exercise component 300 moves relative to the first exercise component 200, the second exercise component 300 does not interfere with the flow regulating valve 3, and the two exercise components may form certain protection for the flow regulating valve 3, so as to avoid the failure of the flow regulating valve 3 due to impact of an external force.

Optionally, the first exercise component 200 is rod-shaped, and the length direction of the flow regulating valve 3 is parallel to the length direction of the first exercise component 200 and is provided on one side of the first exercise component 200 facing the second exercise component 300 in a folded state, so as to obtain a compact overall structure and play a role in protecting the flow regulating valve 3 which is a key component.

In some embodiments, the communication module is used for being communicatively connected to the mobile device, such as being wiredly connected to the first mobile device, or wirelessly connected to the mobile device. The first processor may include a communication module, and by providing the communication module, the first mobile device is communicatively connected to the damping mechanism 100. Specifically, the first processor is electrically connected to the pressure sensor 14, the linear driving mechanism 31 of the flow regulating valve 3, the control switch, the first state display portion, the driving mechanism of the second lead screw 211, and the like, the first processor may acquire the fluid resistance (a pressure value detected by the pressure sensor 14) and the fluid direction (which may be obtained through the rotation direction of the second lead screw 211), the first processor may transmit the above fluid information to the first mobile device, the first mobile device issues control data to the first processor, and the direction of the fluid movement and the fluid resistance are varied by controlling the linear driving mechanism 31 of the flow regulating valve 3, the driving mechanism of the second lead screw 211, and the like by the first processor, so as to adjust the fluid resistance in time more accurately.

The first mobile device is electrically connected to the first processor, and the first mobile device may specify an exercise course and issue instructions such as control information to the first processor, and may also process data such as the fluid information transmitted by the first processor. The first mobile device may further have the first state display portion for displaying the magnitude of the resistance at a holding part or other key parts, a degree of exercise action completion, a degree of exercise course completion, and the like in real time.

In some embodiments, the pressure sensor 14 is used for detecting the pressure of the fluid, namely, may detect the fluid resistance. The pressure sensor 14 may be provided near the fluid passage 331.

In some embodiments, the control switch is used for regulating the direction and/or the magnitude of the preset resistance value, the control switch is electrically connected to the first processor, the first processor is electrically connected to the flow regulating valve 3 and the driving mechanism of the second lead screw 211, the control switch may regulate the direction and/or the magnitude of the preset resistance value and send the direction and/or the magnitude to the first processor, and the first processor correspondingly controls the flow regulating valve 3, the driving mechanism of the second lead screw 211, and the like, so that the magnitude and the direction of the fluid resistance may be controlled, wherein the control switch may be provided on the connecting assembly as a mechanical or electric switch, and may also be provided on the mobile device as a mechanical and electric switch or a touch control switch.

In some embodiments, the first state display portion is used for displaying information of the first device, including the magnitude of the fluid resistance, the direction of the fluid resistance, the switching state of the exercise system, and the like. The first state display portion may be provided on the mobile device or on the connecting assembly, and may be displayed through a display screen, or may be displayed in the form of an LED lamp, and the like.

In some embodiments, the second processor is used for receiving and/or processing a real-time resistance numerical value obtained from fluid pressure information and displaying the real-time resistance numerical value on the first state display portion. The second processor may be provided integrally with the first processor, may also be provided on the damping mechanism 100, or may be provided on the first mobile device.

In some embodiments of the present application, the exercise system further includes a second mobile device 4, a Bluetooth module for controlling connection between the second mobile device 4 and the first processor, and a second state display portion for displaying information of a second device.

The second mobile device 4 may be a device detachably connected to the connecting assembly and/or the damping mechanism 100, and the second mobile device 4 may be a button-type remote control which can be removed from the connecting assembly and/or the damping mechanism 100, and may be mounted to different positions on the connecting assembly and/or the damping mechanism 100 to detect angular movement at different positions. Meanwhile, the second mobile device 4 may be interconnected with the first processor through the Bluetooth module.

The Bluetooth module is connected to the mobile device and the damping mechanism 100, and the Bluetooth module is used for controlling the switching of Bluetooth between the mobile device and the first processor, so that the Bluetooth communicative connection between the second mobile device 4 and the first processor may be controlled. When the Bluetooth of the mobile device and the first processor are simultaneously turned on, the two may be connected through Bluetooth.

The second state display portion is used for displaying information of a second device, including a state of Bluetooth connection, and the like. The second state display portion may be provided on the mobile device and displayed by means of application software, and the like, and the second state display portion may also be provided on the damping mechanism 100, for example, the damping mechanism 100 is provided with a display screen for displaying the second state display portion.

In some embodiments of the present application, the second mobile device further includes a movement state sensing system for acquiring a movement state at the holding part of the connecting assembly and sending movement state information to the first processor and/or the first mobile device. The movement state sensing system is electrically connected to the first processor, so that the first processor may acquire the movement state at the holding part of the connecting assembly.

In some embodiments, the movement state sensing system includes an accelerometer or a gyroscope which are both angular movement detection apparatuses for precisely determining an orientation, attitude, angular velocity, and the like of a moving object.

In some embodiments, the accelerometer or the gyroscope is provided in the button-type remote control.

In some embodiments, at least one accelerometer or gyroscope is detachably arranged at designated positions on different connecting assemblies.

Preferably, the designated position has a shape matching a detachable part.

Preferably, the designated position is near a hand-held position or other critical body parts such as a knee.

In some embodiments, the exercise system further includes a third state display portion and a third processor for comprehensively processing movement state information and/or resistance information to obtain measured exercise information and displaying the measured exercise information on the third state display portion, wherein the measured exercise information includes a degree of action completion and a degree of course completion, the degree of action completion may be in the form of text or graphics such as a color digital progress bar, the degree of action completion may be displayed simultaneously when displaying images, videos and animations corresponding to action states and/or corresponding body parts, and the degree of course completion includes a combination of different intensities, durations and sequences of different actions.

In some embodiments, the exercise system further includes a memory for storing course information of at least one user and a plurality of pieces of measured exercise information of the user.

In some embodiments, the third processor may also perform statistics on the plurality of pieces of measured exercise information of the at least one user to obtain a variation trend of the measured exercise information and display the variation trend on a fourth state display portion, and the fourth state display portion is provided on a mobile device and displayed by means of application software, and the like.

In some embodiments of the present application, the exercise system includes a handlebar structure 600 connected to the second exercise component 300, and the handlebar structure 600 is connected to the second exercise component 300 to allow the second exercise component 300 to rotate relative to the second exercise component 300 when an exercise person holds the handlebar structure 600 and applies certain strength to the handlebar structure 600, so as to achieve an exercise effect.

In some embodiments, the first exercise component 200 and the second exercise component 300 are each provided with the handlebar structure 600, and two hands of the exercise person respectively hold the two handlebar structures 600, so that the first exercise component 200 and the second exercise component 300 rotate relative to each other, so as to achieve the exercise effect.

In some embodiments, the second exercise component 300 is provided with the handlebar structure 600, the first exercise component 200 is fixedly provided, for example, fixed on the exercise bottom plate structure 400, and the handlebar structure 600 is held to rotate relative to the first exercise component 200, so as to achieve the exercise effect.

In some embodiments, with reference to FIG. 10, the damping mechanism 100, the first exercise component 200 and the second exercise component 300 constitute a damping assembly, and the connecting assembly further includes the exercise bottom plate structure 400 and a connecting rod 500, wherein the first exercise components 200 of the two damping assemblies are both fixed on the exercise bottom plate structure 400, and the second exercise components 300 of the two damping assemblies are both fixed on the connecting rod 500, so that the two damping assemblies are provided side by side, and the exercise person holds the connecting rod 500 to rotate the connecting rod 500 relative to the first exercise components 200, so as to achieve the exercise effect.

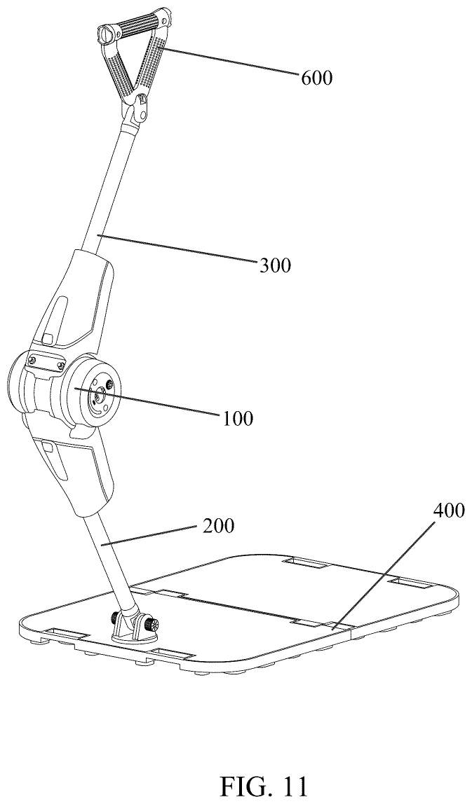

In some embodiments, with reference to FIG. 11, the connecting assembly includes one damping assembly, the handlebar structure 600 and the exercise bottom plate structure 400. The first exercise component 200 is fixed on the exercise bottom plate structure 400, and the second exercise component 300 is fixed on the handlebar structure 600. The exercise person holds the handlebar structure 600 to rotate the handlebar structure 600 relative to the first exercise components 200, so as to achieve the exercise effect.

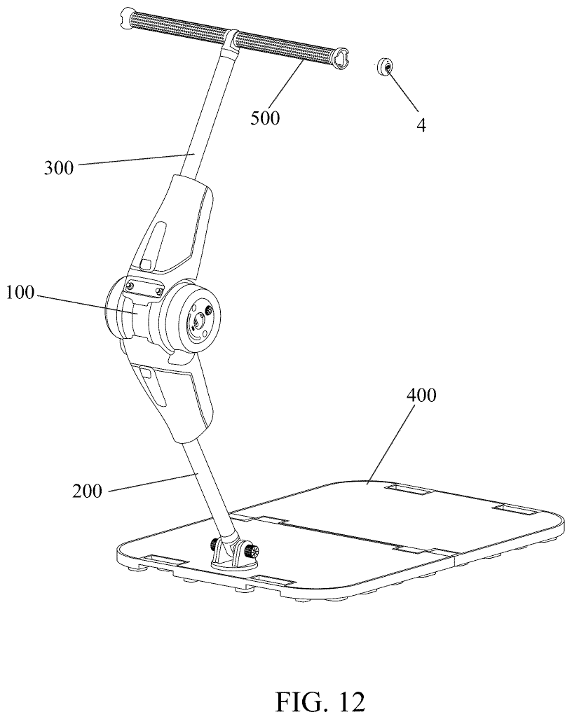

In some embodiments, with reference to FIG. 12, the connecting assembly includes one damping assembly, and further includes the exercise bottom plate structure 400 and the connecting rod 500, wherein the first exercise component 200 is fixed on the exercise bottom plate structure 400, and the second exercise component 300 is fixed on the connecting rod 500. Two hands of the exercise person hold the connecting rod 500 to rotate the connecting rod 500 relative to the first exercise components 200, so as to achieve the exercise effect.

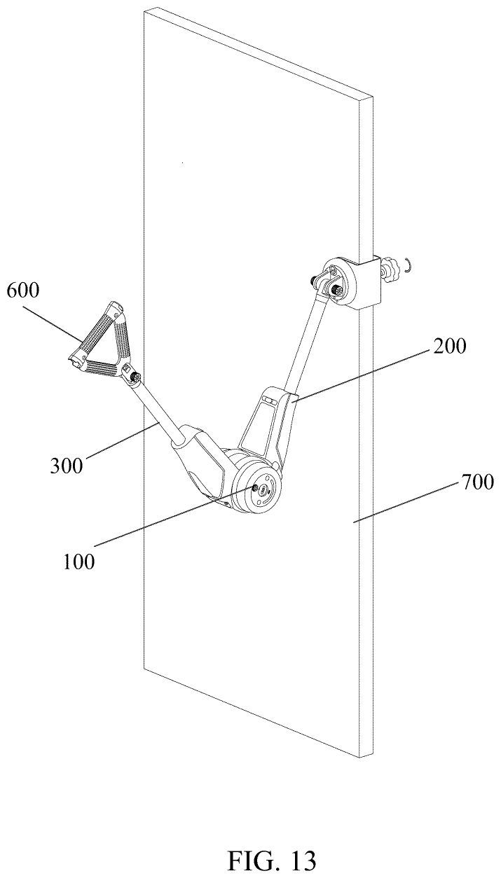

In some embodiments, with reference to FIG. 13, the connecting assembly includes one damping assembly, the handlebar structure 600 and a vertical plate 700, wherein the first exercise component 200 is fixed on the vertical plate 700, and the second exercise component 300 is fixed on the handlebar structure 600. The exercise person holds the handlebar structure 600 to rotate the handlebar structure 600 relative to the first exercise components 200, so as to achieve the exercise effect.

The foregoing is merely optional embodiments of the present application and are not to be construed as limiting the present application. For a person skilled in the art, various modifications and variations may be made to the present application. Any alteration, equivalent substitution, improvement, and the like made within the spirit and principle of the present application shall be included in the scope of the claims of present application.

1. A damping mechanism providing resistance for an exercise system, connected between a first exercise component and a second exercise component which move relative to each other, and capable of providing resistance stabilized at a preset value in various movement states with different strength and velocities, wherein the damping mechanism comprises:
a fixing portion connected to the first exercise component, the fixing portion having a chamber for accommodating a fluid;
a movable portion connected to the second exercise component, the movable portion being at least partially provided in the chamber and dividing the chamber into at least two fluid chambers, fluid volumes in the two fluid chambers having opposite variation trends, a fluid passage being connected between the two fluid chambers, and the movable portion being driven to move in the chamber when the first exercise component and the second exercise component move relative to each other to push the fluid to flow from one of the fluid chambers into the other fluid chamber through the fluid passage; and
at least one flow regulating valve used for regulating a magnitude of fluid resistance in the fluid passage;
a pressure sensor used for acquiring pressure data of the fluid; and
a first processor used for receiving the preset value of the resistance and the pressure data varying in real time, obtaining a real-time control instruction of the flow regulating valve after comprehensive processing, and issuing the real-time control instruction to the flow regulating valve, so as to control the fluid resistance to be kept within a preset value range in different movement states by dynamically regulating the flow regulating valve.

2. The damping mechanism according to claim 1, wherein when a valve core assembly of the flow regulating valve regulates a cross-sectional size of the fluid passage, a cross-sectional shape where the fluid passage matches the flow regulating valve remains unvaried.

3. The damping mechanism according to claim 1, wherein the flow regulating valve comprises a linear driving mechanism, a valve body and the valve core assembly capable of extending into the valve body, the valve body has the fluid passage, two ends of the fluid passage are respectively communicated with the two fluid chambers, the linear driving mechanism is connected to the valve core assembly and used for driving the valve core assembly to move linearly, and the linear driving mechanism is electrically connected to the first processor to control a flow velocity of the fluid in the fluid passage through a position of the valve core assembly in the valve body.

4. The damping mechanism according to claim 3, wherein the linear driving mechanism comprises a motor capable of outputting rotational movement, a first lead screw driven by the motor to rotate, and a first threaded sleeve connected to the first lead screw, the valve core assembly is fixedly connected to the first threaded sleeve, and a cross section of a runner in the fluid passage is controlled by controlling the number of turns of rotation of the first lead screw, so as to regulate flow resistance.

5. The damping mechanism according to claim 3, wherein two ends of the fluid passage respectively extend to be communicated with the two fluid chambers, so that the valve body is directly communicated with the fluid chambers; or the valve body is connected to the fluid chambers through fluid hoses, one end of the fluid hose is communicated with the fluid passage, and the other end thereof is communicated with the fluid chamber.

6. The damping mechanism according to claim 3, wherein the valve core assembly comprises a plug driven by the linear driving mechanism and a volume-variable sealing structure, the valve body is provided with an extension opening through which the plug extends into the fluid passage, one end of the sealing structure is sealingly connected to the plug, the other end of the sealing structure is fixed to a periphery of the extension opening, the plug is provided inside the sealing structure, and a sealing chamber is formed between the sealing structure and the plug.

7. The damping mechanism according to claim 6, wherein the sealing structure comprises a folding cylinder capable of being folded and unfolded and a fixing plate connected to one end of the folding cylinder, one end of the plug is fixed to the fixing plate, the other end of the plug is used for extending into the fluid passage, and one end of the folding cylinder away from the fixing plate is sealingly connected to the periphery of the extension opening.

8. The damping mechanism according to claim 6, wherein the plug is sealingly connected to the extension opening, and an outer peripheral wall of the plug is provided with a pressure relief groove for communicating the fluid passage and the sealing chamber.

9. The damping mechanism according to claim 8, wherein a sealing member is provided at the periphery of the extension opening, the plug comprises a connecting section and a plugging section for extending into the fluid passage, the pressure relief groove is provided at the plugging section, a blocking step is formed at a junction of the connecting section and the plugging section, and the blocking step is used for compressing the sealing member.

10. The damping mechanism according to claim 1, wherein the movable portion comprises a power push plate and a transmission assembly, the power push plate is provided between the two fluid chambers, the second exercise component is connected to a power input end of the transmission assembly, the power push plate is connected to a power output end of the transmission assembly, and the transmission assembly is used for outputting rotational movement of the second exercise component as linear movement of the power push plate.

11. The damping mechanism according to claim 10, wherein the transmission assembly comprises a second lead screw and a second threaded sleeve, the second threaded sleeve is threadedly connected to the second lead screw, the second exercise component is fixedly connected to the second lead screw, and the power push plate is fixedly connected to the second threaded sleeve.

12. The damping mechanism according to claim 11, wherein a ratio of an axial length of the second threaded sleeve to a length of the second lead screw is less than 0.5, matching threads between the second threaded sleeve and the second lead screw are multi-start threads in a trapezoidal thread profile, the number of starts of the threads is 10 to 30, and a lead angle of the threads is 40 degrees to 60 degrees.

13. The damping mechanism according to claim 11, wherein the fixing portion comprises two fluid driving structures, the fluid driving structures have the fluid chambers, the fluid driving structure comprises a first end plate, a second end plate and a folding unit, two ends of the folding unit are respectively connected to the first end plate and the second end plate, the two second end plates are both fixedly connected to the power push plate, and two ends of the second lead screw are rotatably supported on the two first end plates.

14. The damping mechanism according to claim 13, wherein the folding unit is cylindrical, and the fluid chamber is formed by enclosure of the first end plate, the second end plate and an inner wall of the folding unit; or
the fixing portion further comprises a housing structure, the folding unit, the transmission assembly and the power push plate are all positioned in the housing structure, the folding unit is cylindrical, and the fluid chamber is formed by enclosure of the first end plate, the second end plate, an inner wall of the housing structure and an outer wall of the folding structure.

15. The damping mechanism according to claim 13, further comprising a second guide rod and a guide sleeve sleeved on the second guide rod, wherein two ends of the second guide rod are respectively fixed to the two first end plates, the second guide rod is parallel to the second lead screw, and the guide sleeve is fixedly connected to the power push plate.

16. An exercise system, comprising at least one damping mechanism according to claim 1, at least one connecting assembly for implementing an exercise action, a communication module for communicative connection with a first mobile device, a pressure sensor for detecting fluid pressure, a control switch for regulating a direction and/or a magnitude of a preset resistance value, a first state display portion for displaying information of a first device, and a second processor for receiving and/or processing a real-time resistance numerical value obtained from fluid pressure information and displaying the real-time resistance numerical value on the first state display portion, wherein the connecting assembly comprises a first exercise component and a second exercise component.

17. The exercise system according to claim 16, further comprising a second mobile device, a Bluetooth module for connecting the second mobile device with the first processor, and a second state display portion for displaying information of a second device.

18. The exercise system according to claim 17, wherein the second mobile device further comprises a movement state sensing apparatus for acquiring a movement state at a holding part of the connecting assembly, and the movement state sensing apparatus is capable of sending movement state information to the first processor and/or the first mobile device.

19. The exercise system according to claim 18, further comprising a third state display portion and a third processor for comprehensively processing movement state information and/or resistance information to obtain measured exercise information and displaying the measured exercise information on the third state display portion, wherein the measured exercise information comprises a degree of action completion and/or a degree of course completion.

20. The exercise system according to claim 19, further comprising a memory for storing course information of at least one user and a plurality of pieces of measured exercise information of the user, wherein the third processor is capable of performing statistics on the plurality of pieces of measured exercise information of the at least one user to obtain a variation trend of the measured exercise information and displaying the variation trend on a fourth state display portion, and the fourth state display portion is provided on a mobile device.
